(19) United States
(12) Patent Application Publication
(10) Pub. No.: US 2024/0428423 A1
(43) Pub. Date: Dec. 26, 2024

(54) MEDICAL IMAGE PROCESSING APPARATUS, METHOD, AND NON-TRANSITORY COMPUTER READABLE MEDIUM

(71) Applicant: CANON MEDICAL SYSTEMS CORPORATION, Tochigi (JP)

(72) Inventor: Gakuto AOYAMA, Kawasaki (JP)

(73) Assignee: CANON MEDICAL SYSTEMS CORPORATION, Tochigi (JP)

(21) Appl. No.: 18/743,887

(22) Filed: Jun. 14, 2024

(30) Foreign Application Priority Data
Jun. 26, 2023 (JP) 2023-104435

(51) Int. Cl. G06T 7/12; G06T 7/155

(52) U.S. Cl. CPC G06T 7/12; G06T 7/155; G06T 2207/20036; G06T 2207/30004

(57) ABSTRACT

The medical image processing apparatus according to an exemplary embodiment includes processing circuitry. The processing circuitry is configured to extract a region of interest from a medical image. The processing circuitry is configured to identify a reference plane or a reference line based on the region of interest. The processing circuitry is configured to correct the identified reference plane or the identified reference line based on a morphology of the region of interest.

### CROSS-REFERENCE TO RELATED APPLICATIONS

This application is based upon and claims the benefit of priority from Japanese Patent Application No. 2023-104435, filed Jun. 26, 2023, the entire contents of which are incorporated herein by reference.

### FIELD

The present disclosure relates to a medical image processing apparatus, a method, and a non-transitory computer readable medium.

### BACKGROUND

Catheter-based left atrial appendage closure (LAAC) has recently been attracting attention as a measure for stroke prevention. In LAAC, a treatment device is placed in the left atrial appendage (LAA) to prevent blood flow and clot formation in the LAA. To determine the size and placement position of the treatment device to be placed in the LAA, measurement based on morphological information about the LAA and the ostium of the LAA is to be made. The LAA ostium refers to the border between the LAA and the left atrium (LA), a region at the entrance of the LAA. A section perpendicular to the axis of the LAA in the ostium region will be referred to as an ostium plane. The ostium plane is a two-dimensional plane, and the ostium region is drawn as a circle on the ostium plane. There are several previous papers discussing means for identifying the ostium plane in a computed tomography (CT) image.

The use of conventional organ segmentation techniques is being contemplated as a method for identifying a reference plane or a reference line based on a region of interest (e.g., LAA), like the ostium plane described above. However, the method using organ segmentation techniques can have difficulty in identifying a reference plane or a reference line with clinically sufficient accuracy. That is, the treatment device may be unable to be actually placed along the identified reference plane or the identified reference line.

### BRIEF DESCRIPTION OF THE DRAWINGS

FIG. 1 is a diagram illustrating a configuration example of a medical image processing apparatus according to a first exemplary embodiment.

FIG. 2 is a flowchart illustrating a processing procedure for processing to be performed by processing functions that processing circuitry of the medical image processing apparatus according to the first exemplary embodiment has.

FIG. 3 is a diagram for describing processing to be performed by an identification function according to the first exemplary embodiment.

FIG. 4A is a diagram for describing an example of morphological information about a treatment device according to the first exemplary embodiment.

FIG. 4B is a diagram for describing an example of morphological information about a treatment device according to the first exemplary embodiment.

FIG. 5 is a diagram for describing an example of determination processing to be performed by a correction function according to the first exemplary embodiment.

FIG. 6 is a diagram for describing an example of determination processing to be performed by a correction function according to the first exemplary embodiment.

FIG. 7 is a diagram for describing an example of correction processing to be performed by the correction function according to the first exemplary embodiment.

FIG. 8 is a diagram illustrating a display example according to the first exemplary embodiment.

FIG. 9 is a diagram illustrating a configuration example of a medical image processing apparatus according to a second exemplary embodiment.

FIG. 10 is a flowchart illustrating a processing procedure for processing to be performed by processing functions that processing circuitry of the medical image processing apparatus according to the second exemplary embodiment has.

FIG. 11 is a diagram for describing an example of determination processing by a correction function according to the second exemplary embodiment.

FIG. 12 is a diagram for describing an example of correction processing by the correction function according to the second exemplary embodiment.

### DETAILED DESCRIPTION

A medical image processing apparatus according to an exemplary embodiment includes processing circuitry. The processing circuitry is configured to extract a region of interest from a medical image. The processing circuitry is configured to identify a reference plane or a reference line based on the region of interest. The processing circuitry is configured to correct the identified reference plane or the identified reference line based on a morphology of the region of interest.

Exemplary embodiments of a medical image processing apparatus, a method, and a non-transitory computer readable medium according to the present application will be described in detail below with reference to the accompanying drawings. The medical image processing apparatus, method, and non-transitory computer readable medium according to the present application are not limited to the following exemplary embodiments. In the following description, similar components are denoted by the same reference numerals. A redundant description thereof will be omitted.

### First Exemplary Embodiment

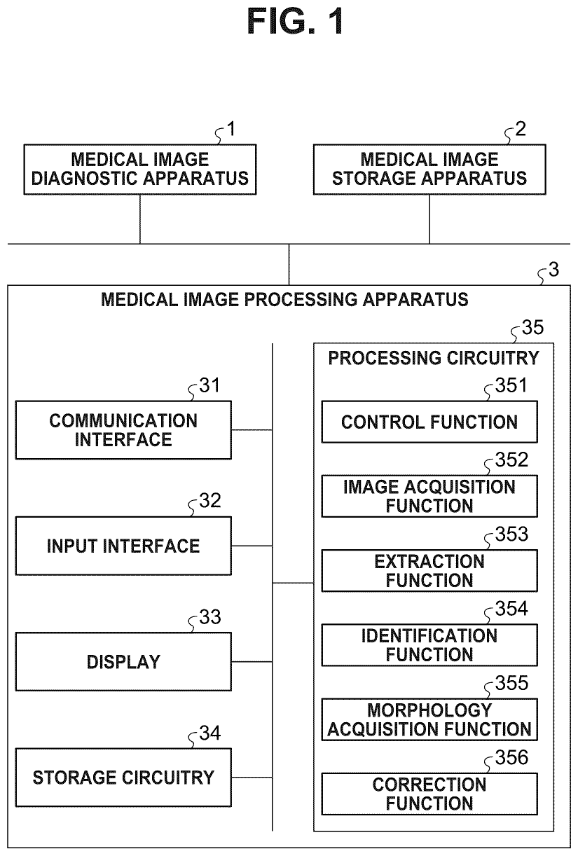

FIG. 1 is a diagram illustrating a configuration example of a medical image processing apparatus according to a first exemplary embodiment. A medical image processing apparatus 3 according to the present exemplary embodiment is, for example, communicably connected to a medical image diagnostic apparatus 1 and a medical image storage apparatus 2 via a network, as illustrated in FIG. 1. Various other apparatuses and systems can also be connected to the network illustrated in FIG. 1.

The medical image diagnostic apparatus 1 captures an image of a subject to generate a medical image. The medical image diagnostic apparatus 1 transmits the generated medical image to various apparatuses on the network. Examples of the medical image diagnostic apparatus 1 includes an X-ray diagnostic device, an X-ray computed tomography (CT) device, a magnetic resonance imaging (MRI) device, an ultrasonic diagnostic device, a single photon emission computed tomography (SPECT) device, and a positron emission computed tomography (PET) device.

The medical image storage apparatus 2 stores various medical images related to subjects. Specifically, the medical image storage apparatus 2 receives medical images from the medical image diagnostic apparatus 1 via the network and stores the medical images in a storage circuit in the medical image diagnostic apparatus 1. For example, the medical image storage apparatus 2 is implemented by a computer device, such as a server or a workstation. As an example, the medical image storage apparatus 2 is implemented by a picture archiving and communication system (PACS) and stores medical images in a format compliant with Digital Imaging and Communications in Medicine (DICOM).

The medical image processing apparatus 3 performs various types of image processing on medical images collected from subjects. Specifically, the medical image processing apparatus 3 receives medical images from the medical image diagnostic apparatus 1 or the medical image storage apparatus 2 via the network, and performs various types of information processing using the medical images. For example, the medical image processing apparatus 3 is implemented by a computer device, such as a server or a workstation.

The medical image processing apparatus 3 includes, for example, a communication interface 31, an input interface 32, a display 33, storage circuitry 34, and processing circuitry 35.

The communication interface 31 controls transmission and communication of various types of data communicated between the medical image processing apparatus 3 and other apparatuses connected via the network. Specifically, the communication interface 31 is connected to the processing circuitry 35, and transmits data received from another apparatus to the processing circuitry 35 or transmits data received from the processing circuitry 35 to another apparatus. The communication interface 31 is implemented by, for example, a network card, a network adaptor, or a network interface controller (NIC).

The input interface 32 receives input operations for various instructions and various types of information from a user. Specifically, the input interface 32 is connected to the processing circuitry 35, and converts the input operations received from the user into electrical signals and transmits the electrical signals to the processing circuitry 35. For example, the input interface 32 is implemented by a trackball, a switch button, a mouse, a keyboard, a touchpad to which input operations are made with a touch on the operation surface, a touchscreen into which a display screen and a touchpad are integrated, a noncontact input interface using an optical sensor, and/or a voice input interface. As employed herein, the input interface 32 is not limited to ones including physical operation components, such as a mouse and a keyboard. Examples of the input interface 32 may include an electrical signal processing circuit that receives an electrical signal corresponding to an input operation from an external input device provided separately from the medical image processing apparatus 3 and transmits this electrical signal to the processing circuitry 35.

The display 33 displays various types of information and various types of data. Specifically, the display 33 is connected to the processing circuitry 35, and displays various types of information and various types of data received from the processing circuitry 35. For example, the display 33 is implemented by a liquid crystal display, a cathode ray tube (CRT) display, or a touchscreen.

The storage circuitry 34 stores various types of data and various programs. Specifically, the storage circuitry 34 is connected to the processing circuitry 35, and stores data received from the processing circuitry 35 or reads stored data and transmits the read data to the processing circuitry 35. For example, the storage circuitry 34 is implemented by a semiconductor memory device, such as a random access memory (RAM) and a flash memory, a hard disk, and/or an optical disc.

The processing circuitry 35 controls the entire medical image processing apparatus 3. For example, the processing circuitry 35 performs various types of processing based on input operations received from the user via the input interface 32. For example, the processing circuitry 35 receives data transmitted from another apparatus via the communication interface 31 and stores the received data in the storage circuitry 34. For example, the processing circuitry 35 transmits data received from the storage circuitry 34 to the communication interface 31 and thereby transmits the data to another apparatus. For example, the processing circuitry 35 displays data received from the storage circuitry 34 on the display 33.

The configuration example of the medical image processing apparatus 3 according to the present exemplary embodiment has been described above. For example, the medical image processing apparatus 3 according to the present exemplary embodiment is installed in a medical facility such as a hospital and a clinic, and supports various diagnoses and treatment planning which are made by users, such as doctors. More specifically, the medical image processing apparatus 3 enables identification of a reference plane or a reference line suitable for clinical use by correcting a reference plane or reference line serving as a reference position in measuring a region of interest or determining a treatment device during treatment planning based on the morphology of the region of interest. Here, the reference plane or the reference line is a position derived from the region of interest. The medical image processing apparatus 3 with such a configuration will now be described in detail.

For example, as illustrated in FIG. 1, the processing circuitry 35 of the medical image processing apparatus 3 performs a control function 351, an image acquisition function 352, an extraction function 353, an identification function 354, a morphology acquisition function 355, and a correction function 356 in the present exemplary embodiment. Here, the extraction function 353 is an example of an extraction unit. The identification function 354 is an example of an identification unit. The morphology acquisition function 355 is an example of a morphology acquisition unit. The correction function 356 is an example of a correction unit and a setting unit.

The control function 351 generates various graphical user interfaces (GUIs) and/or various types of display information based on operations made via the input interface 32, and controls display of the generated GUIs and/or display information on the display 33. For example, the control function 351 displays results of processing performed with various functions on the display 33. The control function 351 can also generate various display images based on medical images acquired by the image acquisition function 352 and display the display images.

The image acquisition function 352 acquires a medical image of a subject from the medical image diagnostic apparatus 1 or the medical image storage apparatus 2 via the communication interface 31. Specifically, the image acquisition function 352 acquires a medical image containing morphological information about a three-dimensional anatomical structure of the region of interest to be processed. Here, the image acquisition function 352 can acquire a plurality of medical images obtained by capturing a plurality of three-dimensional images in a time direction.

The image acquisition function 352 acquires CT images, ultrasonic images, MRI images, X-ray images, or angiographic images as the foregoing medical images. The processing circuitry 35 receives medical images of the subject from the medical image diagnostic apparatus 1 or the medical image storage apparatus 2 by performing the image acquisition function 352 described above, and stores the received medical images in the storage circuitry 34.

The extraction function 353 extracts the region of interest from a medical image acquired by the image acquisition function 352. The processing to be performed by the extraction function 353 will be described in detail below.

The identification function 354 identifies a reference plane or reference line based on the region of interest. The processing to be performed by the identification function 354 will be described in detail below.

The morphology acquisition function 355 acquires the morphology of a treatment device to be placed in the region of interest. The processing to be performed by the morphology acquisition function 355 will be described in detail below.

The correction function 356 corrects the identified reference plane or reference line based on the morphology of the region of interest. Specifically, the correction function 356 corrects the reference plane or the reference line based on a relationship between the morphology of the region of interest and that of the treatment device. For example, the correction function 356 sets a candidate placement position of the treatment device based on the reference plane or the reference line, and corrects the reference plane or the reference line based on a relationship between the state of the treatment device placed at the candidate placement position and the morphology of the region of interest. The processing to be performed by the correction function 356 will be described in detail below.

The processing circuitry 35 described above is implemented by, for example, a processor. In such a case, the foregoing various processing functions are stored in the storage circuitry 34 in the form of computer-executable programs. The processing circuitry 35 implements the functions corresponding to the respective programs by reading the programs stored in the storage circuitry 34 and executing the programs. In other words, the processing circuitry 35 comes to have the processing functions illustrated in FIG. 1 when the respective programs are read.

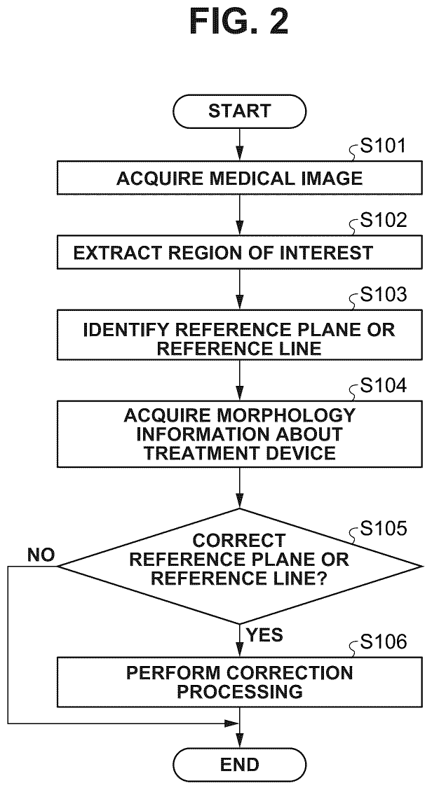

Next, a processing procedure of the medical image processing apparatus 3 will be described with reference to FIG. 2, and then details of each process will be described. FIG. 2 is a flowchart illustrating a processing procedure for processing performed with the processing functions that the processing circuitry 35 of the medical image processing apparatus 3 according to the first exemplary embodiment has.

For example, as illustrated in FIG. 2, the image acquisition function 352 acquires, in step S101, a medical image of the subject from the medical image diagnostic apparatus 1 or the medical image storage apparatus 2 in the present exemplary embodiment. For example, the image acquisition function 352 acquires a medical image containing morphological information about the anatomical structure of a living organ to be processed based on medical image acquisition operations made via the input interface 32. This processing is implemented, for example, by the processing circuitry 35 calling the program corresponding to the image acquisition function 352 from the storage circuitry 34 and executing the program.

In step S102, the extraction function 353 extracts the region of interest included in the acquired medical image. This processing is implemented, for example, by the processing circuitry 35 calling the program corresponding to the extraction function 353 from the storage circuitry 34 and executing the program.

In step S103, the identification function 354 identifies a reference plane or a reference line based on the extracted region of interest. This processing is implemented, for example, by the processing circuitry 35 calling the program corresponding to the identification function 354 from the storage circuitry 34 and executing the program.

In step S104, the morphology acquisition function 355 acquires morphological information indicating the morphology of the treatment device to be placed in the region of interest. This processing is implemented, for example, by the processing circuitry 35 calling the program corresponding to the morphology acquisition function 355 from the storage circuitry 34 and executing the program.

In step S105, the correction function 356 determines whether to correct the reference plane or reference line identified in step S103. If the correction function 356 determines that the reference plane or reference line is to be corrected (YES in step S105), the processing proceeds to step S106. In step S106, the correction function 356 performs correction processing on the reference plane or reference line identified in step S103. If, in step S105, the correction function 356 determines the reference plane or reference line is determined not to be corrected (NO in step S105), the processing is ended. This processing is implemented, for example, by the processing circuitry 35 calling the program corresponding to the correction function 356 from the storage circuitry 34 and executing the program.

Details of each process performed by the medical image processing apparatus 3 will now be described. The following description deals with a case where the region of interest is the left atrial appendage (LAA). However, this is not restrictive, and the present exemplary embodiment can be targeted for any living organ to which a treatment is applied by placing a device in part or all of the structure. For example, the aortic value or the mitral valve may be the region of interest. In the following description, a case where a CT image captured by an X-ray CT device is obtained as a three-dimensional medical image will be described as an example.

### (Processing for Acquiring Medical Image)

As described in step S101 of FIG. 2, the image acquisition function 352 acquires a medical image containing three-dimensional morphological information about the region of interest based on medical image acquisition operations made via the input interface 32. For example, the image acquisition function 352 acquires a three-dimensionally captured CT image of the LAA.

The operation of the medical image acquisition processing in step S101 may be started based on the user's instruction provided via the input interface 32 as described above, or automatically started. In the latter case, for example, the image acquisition function 352 monitors the medical image storage apparatus 2, and each time a new medical image is stored, automatically acquires the medical image.

Here, the image acquisition function 352 may determine the stored new medical image based on a preset acquisition condition, and if the medical image satisfies the acquisition condition, the image acquisition function 352 may perform the acquisition processing. For example, an acquisition condition based on which the state of the medical image is determinable is stored in the storage circuitry 34, and the image acquisition function 352 determines the stored new medical image based on the acquisition condition stored in the storage circuitry 34.

For example, the storage circuitry 34 stores, as the acquisition condition, “acquisition of a medical image captured using an imaging protocol intended for the heart” or “acquisition of a magnified and reconstructed medical image”, or a combination of these. The image acquisition function 352 acquires a medical image that satisfies the foregoing acquisition condition.

### (Processing for Extracting Region of Interest)

As described in step S102 of FIG. 2, the extraction function 353 extracts the region of interest from the medical image acquired by using the image acquisition function 352. More specifically, the extraction function 353 extracts coordinate information about all or some of pixels representing the LAA in the three-dimensional CT image. Here, the extraction function 353 can extract the region of interest using various techniques. For example, the extraction function 353 can extract a region specified on the CT image via the input interface 32 as the region of interest (LAA). In other words, the extraction function 353 extracts the region manually specified by the user as the LAA.

As another example, the extraction function 353 can extract the region of interest based on an anatomical structure drawn on the CT image with a known region extraction technique. For example, the extraction function 353 extracts the region of interest in the CT image using Otsu's binarization, region growing, snake algorithm, graph cut, or mean shift based on CT values.

As another example, the extraction function 353 can extract the region (coordinate information) of the LAA in the CT image by using a trained model for the region of interest (LAA), constructed using machine learning techniques (including deep learning) based on training data prepared in advance. The region of interest extraction processing described above does not necessarily need to be applied to the entire image. For example, an area that relates to the region of interest and is greater than the region of interest and smaller than the entire image (e.g., if the region of interest is the LAA, the heart area or the left atrium area) may be identified, and the foregoing known region extraction techniques and/or machine learning techniques may be applied to only the identified area to extract the region representing the region of interest.

### (Processing of Identifying Reference Plane or Reference Line)

As described in step S103 of FIG. 2, the identification function 354 identifies the reference plane or reference line based on the region of interest. More specifically, the identification function 354 identifies the reference plane or reference line that relates to the position of the region of interest and serves as a reference position in measuring a measurement value regarding the region of interest or determining the treatment device during treatment planning. For example, the identification function 354 identifies the ostium plane of the LAA extracted by the extraction function 353. More specifically, the identification function 354 identifies information indicating the ostium plane in the CT image by identifying the entrance of the LAA extracted by the extraction function 353.

The identification function 354 can acquire various types of information as the information indicating the ostium plane. For example, the identification function 354 can acquire coordinate information about at least three points included in the border between the left atrium (LA) and the left ventricle as the information indicating the ostium plane. As another example, the identification function 354 can acquire a conversion matrix for converting the position of a characteristic section (e.g., the most cephalic or caudal horizontal section) in the CT image from which the LAA is extracted, into the position of the ostium plane as the information indicating the ostium plane. As another example, the identification function 354 can acquire the center coordinates of the ostium area (area corresponding to the entrance of the LAA) and vector information from a characteristic point (e.g., the point where all the X-, Y-, and Z-coordinates are 0) in the original CT image to the center coordinates of the ostium area.

The identification function 354 can identify the ostium plane using various methods. For example, the identification function 354 can identify an area manually specified using existing image display software based on a procedure discussed in Non-Patent Literature 1 as the ostium plane. As another example, the identification function 354 can estimate an area representing the anatomical structure relating to the ostium plane based on a shape model of the anatomical structure constructed by learning training data prepared in advance using machine learning techniques, and identify the ostium plane based the position of the estimated anatomical structure. For example, the identification function 354 estimates the positions of the coumadin ridge and/or the bifurcation of the left main trunk of the left main coronary artery into the left circumflex branch as anatomical structures relating to the ostium surface, and identifies the ostium plane from the estimated positions of the anatomical structures. Furthermore, the identification function 354 can calculate a two-dimensional plane by applying the least squares method to the closed curve of the border between the LAA area extracted in step S102 and the LA area, and identifies the two-dimensional plane as the ostium plane.

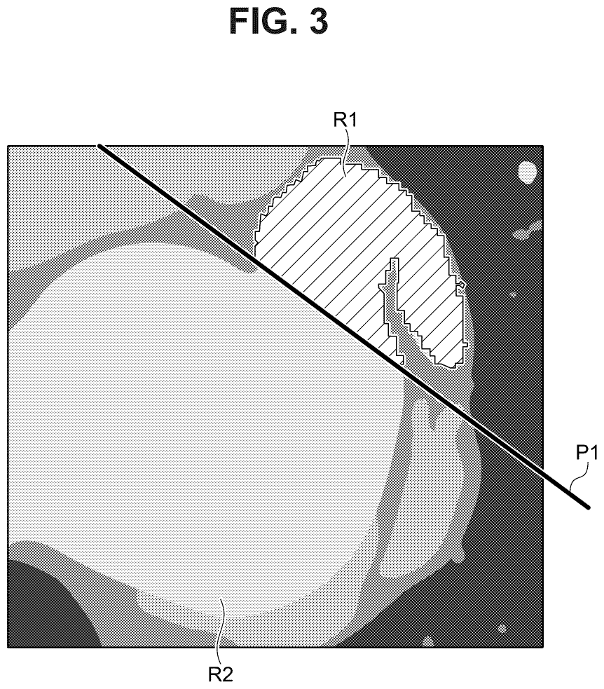

FIG. 3 is a diagram for describing the processing to be performed by the identification function 354 according to the first exemplary embodiment. FIG. 3 illustrates a two-dimensional CT image, whereas the actual processing is performed on a three-dimensional CT image. For example, the identification function 354 identifies information indicating a plane P1 representing the ostium plane at the border between a region R1 representing the LAA and a region R2 representing the LA in the CT image. In other words, the identification function 354 identifies the plane P1 illustrated in FIG. 3 using the foregoing various methods, and acquires the foregoing various types of information as the information indicating the identified plane P1.

(Processing for Acquiring Morphological Information about Treatment Device)

As described in step S104 of FIG. 2, the morphology acquisition function 355 acquires the morphological information about the treatment device to be placed in the region of interest. Specifically, the morphology acquisition function 355 acquires part or all of information about the morphology, such as shape and size, of the treatment device to be placed in the region of interest.

Morphological information about treatment devices that are already in clinical use or under clinical research is made public by the manufacturers and vendors of the treatment devices. The medical image processing apparatus 3 records such morphological information made public in the storage circuitry 34 in association with names or other identification information about the treatment devices in advance. The morphology acquisition function 355 acquires the corresponding morphological information from the storage circuitry 34. Alternatively, for example, the user may define morphological information about user-intended unknown treatment devices by themselves, and store the defined morphological information in the storage circuitry 34.

For example, the storage circuitry 34 stores morphological information about treatment devices for use in left atrial appendage closure (LAAC) for the LAA, the region of interest, in advance. As discussed in Non-Patent Literature: Asmarats, Lluis, and Josep Rodes-Cabau, “Percutaneous left atrial appendage closure: current devices and clinical outcomes”, Circulation: cardiovascular interventions 10.11 (2017): e005359, there are various types of treatment devices for use in LAAC. Morphological information about all such devices may be stored in the storage circuitry 34.

The morphology acquisition function 355 acquires morphological information about a treatment device or devices for use in LAAC from the storage circuitry 34. For example, the morphology acquisition function 355 can obtain the morphological information about all the treatment devices for use in LAAC. As another example, the morphology acquisition function 355 can acquire only the morphological information about one or more predetermined treatment devices. Alternatively, the morphology acquisition function 355 can acquire only the morphological information about a type of treatment device selected by the user via a not-illustrated GUI. If the same type of treatment device has a plurality of size variations, the morphological information about all the sizes may be acquired. The morphological information about a user-specified or predetermined size of treatment device may be acquired. Examples of the predetermined size include a maximum size and a minimum size.

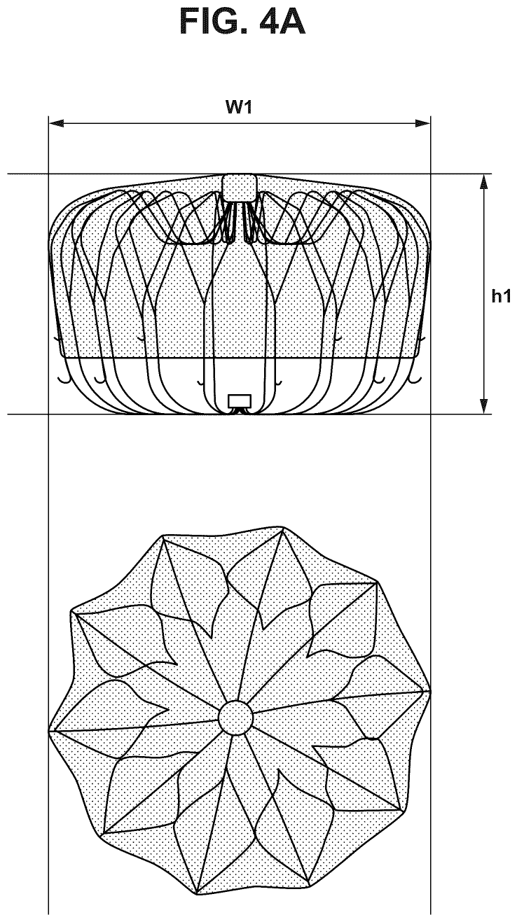

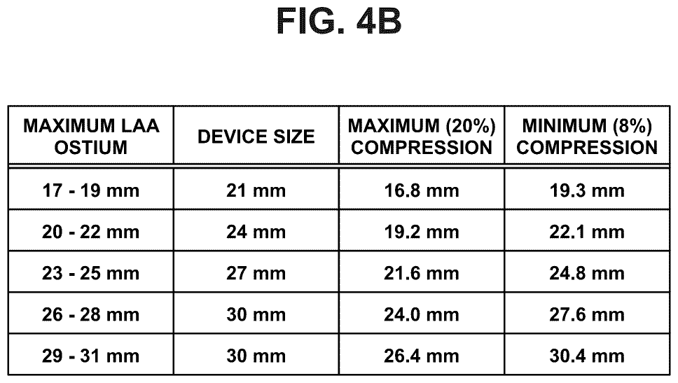

FIG. 4A is a diagram for describing an example of morphological information about a treatment device according to the first exemplary embodiment. FIG. 4A illustrates a WATCHMAN FLX™ device, which is one of the most essential treatment devices used for LAAC. For example, the morphology acquisition function 355 acquires the diameter “w1” and height “h1” of the treatment device illustrated in FIG. 4A.

Treatment devices is designed to be deformed to some extent by compression. The morphological information about the treatment devices can thus include deformation information about their deformable ranges. FIG. 4B is a diagram for describing examples of the morphological information about the treatment devices according to the first exemplary embodiment. As illustrated in FIG. 4B, the morphological information about each treatment device may be stored in the storage circuitry 34 as information in association with a maximum size of the ostium area of the LAA (maximum LAA ostium), the size of the treatment device (device size), the size of the treatment device under maximum compression (maximum [20%] compression), and the size under minimum compression (minimum [8%] compression).

### (Determination Processing Relating to Correction)

As described in conjunction with step S105 of FIG. 2, the correction function 356 determines whether to correct the reference plane or reference line identified by the identification function 354 based on the morphology of the region of interest. More specifically, the correction function 356 determines whether to correct the reference plane or reference line based on the relationship between the morphology of the region of interest and the morphology of the treatment device. For example, the correction function 356 determines whether to correct the reference plane or reference line based on the relationship between the treatment device and the LAA with the treatment device placed along the reference plane or reference line.

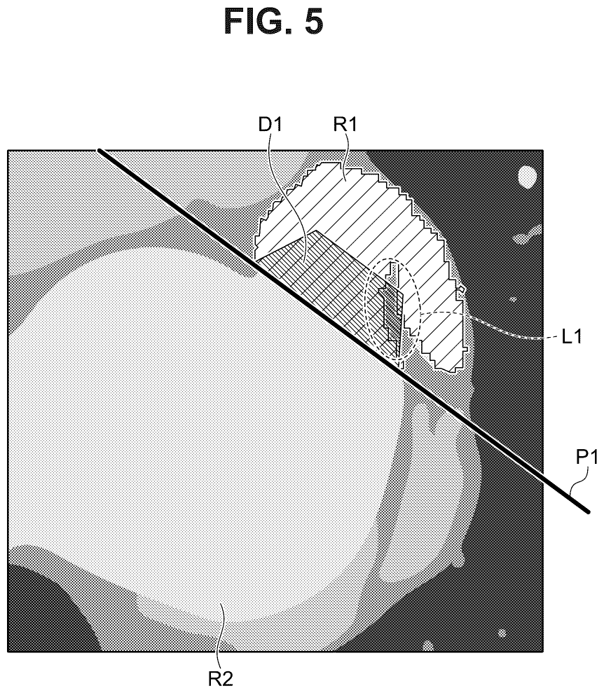

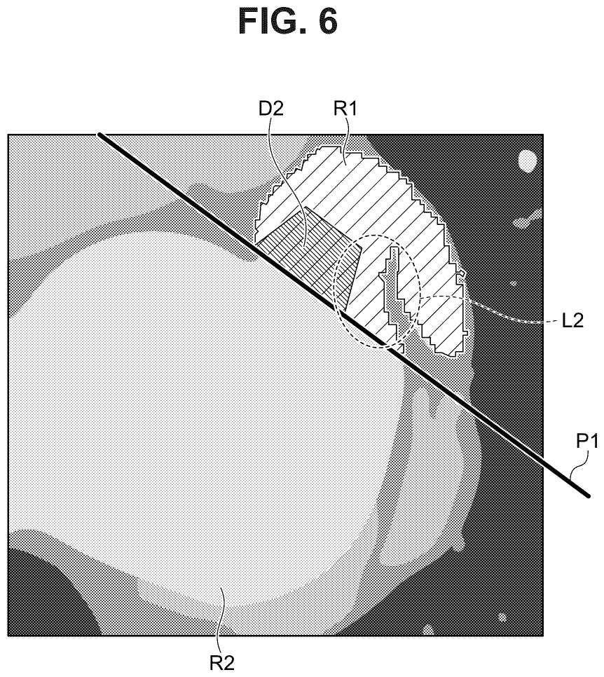

FIGS. 5 and 6 are diagrams for describing an example of the determination processing to be performed by the correction function 356 according to the first exemplary embodiment. FIGS. 5 and 6 illustrate processing after the identification of the plane P1 (ostium plane) illustrated in FIG. 3. For example, the correction function 356 acquires the information about the plane P1 identified by the identification function 354 and the morphological information about the treatment device acquired by the morphology acquisition function 355. The correction function 356 then determines whether to correct the reference plane or reference line based on the placement state of the treatment device for the LAA with the treatment device placed along the plane P1.

In such a case, as illustrated in FIG. 5, the correction function 356 calculates the expected placement position (region D1 in the diagram) of the treatment device based on the plane P1 and the morphological information about the treatment device. The correction function 356 then determines whether to correct the plane P1 based on the positional relationship between the calculated placement position of the treatment device and the LAA. For example, in FIG. 5, the expected placement area (region D1 in the diagram) of the treatment device partially lies outside the contour of the LAA as indicated by the area surrounded by the dotted line L1 in the diagram, so that the treatment device presumably either fails to be placed at this position or is deformed when placed. Thus, the correction function 356 determines that the treatment device is not to be placed along the plane P1, and determines to correct the plane P1.

Suppose, for example, that the expected placement position (region D2 in the diagram) of the treatment device is calculated as illustrated in FIG. 6. As represented by the area surrounded by the dotted line L2 in FIG. 6, the size of the treatment device (region D2) is smaller than that of the LAA (region R1) on the ostium plane and there is a gap between the contour of the LAA and the contour of the treatment device on the ostium plane. This presumably leads to a failure in placement of the treatment device at this position or allows blood flow into the LAA after placement. Thus, the correction function 356 determines that the treatment device is not to be placed along the plane P1, and determines that correction is to be made.

The correction function 356 performs the determination processing based on a geometric relationship between the morphological information about the treatment device and the morphological information about the LAA. For example, the correction function 356 performs the foregoing determination processing by calculating the distance between the contour of the treatment device and that of the LAA and comparing the distance with a predetermined determination criterion. The determination criterion for performing the determination processing may be set and stored in the storage circuitry 34 in advance. Alternatively, the determination method and possible candidates for the determination criterion (e.g., both FIGS. 5 and 6) may be presented on a not-illustrated GUI for user selection. The correction function 356 performs the foregoing determination processing using the preset determination criterion or the user-selected determination criterion. The geometric relationship between the morphological information about the treatment device and the morphological information about the LAA may be any information irrespective of the foregoing distance. For example, the geometric relationship may be information about an angle formed between a surface of the treatment device and a position of the LAA.

In the description provided as an example in conjunction with FIGS. 5 and 6, whether to correct the reference plane or reference line is described as being determined by calculating the positional relationship between the contour of the treatment device and the contour of the LAA on a two-dimensional plane. However, the exemplary embodiment is not limited thereto, and whether to correct the reference plane or reference line may be determined based on a three-dimensional positional relationship. Specifically, since the treatment device and the region of interest (LAA) are three-dimensional structures, the correction function 356 can calculate three-dimensional morphological information and three-dimensional positional relationship information about the treatment device and the LAA, and determine whether to correct the reference plane or reference line based on such information.

Since cardiac structures, such as that of the LAA, change their morphology over time, the relationship between the treatment device and the region of interest may be calculated as a four-dimensional feature amount based a plurality of structures of the region of interest at different points in time. In such a case, the image acquisition function 352, in step S102, acquires medical images at a plurality of points in time which is collected over time. The extraction function 353 extracts the region of interest (such as the LAA) from each of the medical images at the plurality of points in time. The identification function 354 identifies the reference plane or reference line at each point in time.

The correction function 356 corrects the reference plane or reference line based on the relationship between the morphology of the region of interest and that of the treatment device in each time phase. Specifically, the correction function 356 calculates the relationship between the region of interest and the treatment device at each point in time based on the morphology of the treatment device, the morphology of the region of interest at each point in time, and the reference plane (or reference line), and determines whether to correct the reference plane (or reference line) based on the calculations. For example, if the correction function 356 determines that the reference plane or reference line is to be corrected at least one point in time, the correction function 356 determines to make the correction. If the correction function 356 determines that the reference plane or reference line is not to be corrected at any of the points in time, the correction function 356 performs control so that the processing is ended.

### (Correction Processing)

As described in step S106 of FIG. 2, if the correction function 356 determines in step S105 that the reference plane or reference line is to be corrected, the correction function 356 performs correction processing on the reference plane or the reference line. More specifically, the correction function 356 corrects the reference plane or reference line to a position at which the reference plane or reference line is not determined to be corrected with the determination method and the correction criterion with each of which the correction is determined to be made in step S105, based on the positional information about the region of interest extracted in step S102 and the morphological information about the treatment device acquired in step S104.

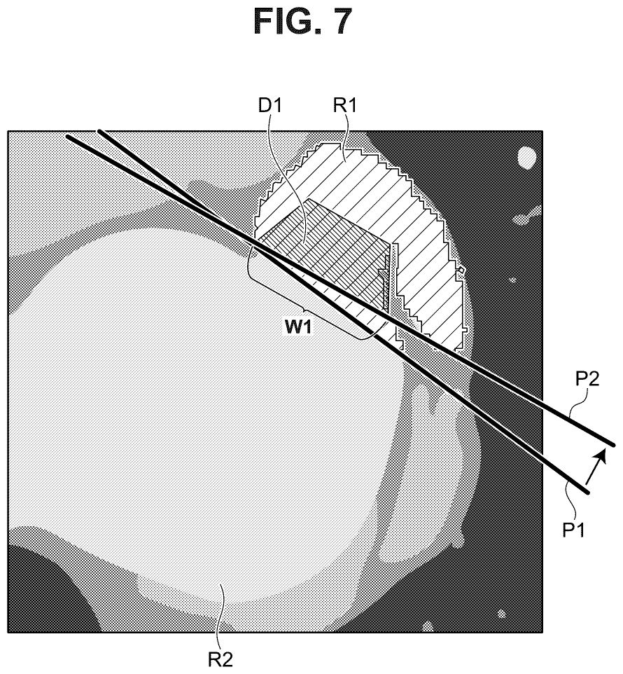

FIG. 7 is a diagram for describing an example of the correction processing to be performed by the correction function 356 according to the first exemplary embodiment. FIG. 7 illustrates the processing after the determination processing in FIG. 5. For example, the correction function 356 searches for a position at which the entire treatment device (region D1) falls within the LAA (range R1) and there is no gap on the LA side and the LAA side of the ostium plane as illustrated in FIG. 7, based on the contour of the region of interest (LAA) and that of the treatment device. The correction function 356 corrects the position of the plane P1 into the position of a plane P2 based on a search result.

Here, the correction function 356 can determine the correction position (the position of the plane P2 in FIG. 7) with various methods. For example, the correction function 356 can calculate a position satisfying the foregoing condition based on the morphological information about the region of interest (LAA) and the treatment device, and determine the calculated position as the correction position. As another example, the correction function 356 can determine the correction position by correcting the position of the plane P1 with a preset amount of correction and correction method (such as 10° rotation, 2-mm translation, or a combination of these), performing the determination processing of step S105 on the corrected position again, and repeating the correction processing and the determination processing until correction is determined to be unnecessary. In such a case, in the processing procedure illustrated in FIG. 2, the correction processing of step S106 is followed by the determination processing of step S105. The operations in steps S105 and S106 are repeated until correction is determined to be unnecessary.

The foregoing repetition of the correction processing and the determination processing may be controlled to end based on a preset number of repetitions or processing time. Specifically, the correction function 356 can perform control so that the processing is ended without correction when the preset number of repetitions or processing time is reached.

The medical image processing apparatus 3 can display a message if there is no correction position satisfying the condition. Specifically, if the correction function 356 determines that there is no correction position satisfying the condition, the control function 351 displays display information to indicate that on the display 33.

### First Modification

In the foregoing exemplary embodiment, in step S104, the morphological information about all or some of the types or sizes of treatment devices determined in advance or specified by the user are described as being acquired. However, the exemplary embodiment is not limited thereto. For example, the type of treatment device about which the morphological information is to be acquired may be determined based on the morphological information about the region of interest acquired in step S102 and/or morphological information about a structure of interest acquired in step S103. For example, the morphology acquisition function 355 acquires the morphological information about the treatment device of the closest size based on a major diameter or a minor diameter of an elliptical closed curve that the ostium area forms on the ostium plane (closed curve corresponding to the entrance of the LAA on the ostium plane).

### Second Modification

Aside from the foregoing processing, the medical image processing apparatus 3 can display various types of display information. For example, the control function 351 can display the corrected reference plane or reference line and the uncorrected position in a juxtaposed or superposed manner. For example, as illustrated in FIG. 7, the control function 351 can generate display information indicating the uncorrected plane P1 and the corrected plane P2 on the CT image including the LA and the LAA, and display the generated display information on the display 33.

Moreover, the medical image processing apparatus 3 can display the positions before and after the correction, and present whether to accept the displayed correction to the user. In such a case, the control function 351 displays on the display 33 a GUI for receiving an operation as to whether to accept the correction, and receives the user's determination via the input interface 32. If the operation to accept the correction is received, the control function 351 ends the processing. If the operation to accept the correction is not received (the correction is not accepted), the control function 351 performs control such that the processing is ended or is returned to step S106. In step S106, the control function 351 controls correction under different conditions. Here, the control function 351 may display a GUI for prompting the user to set the different conditions.

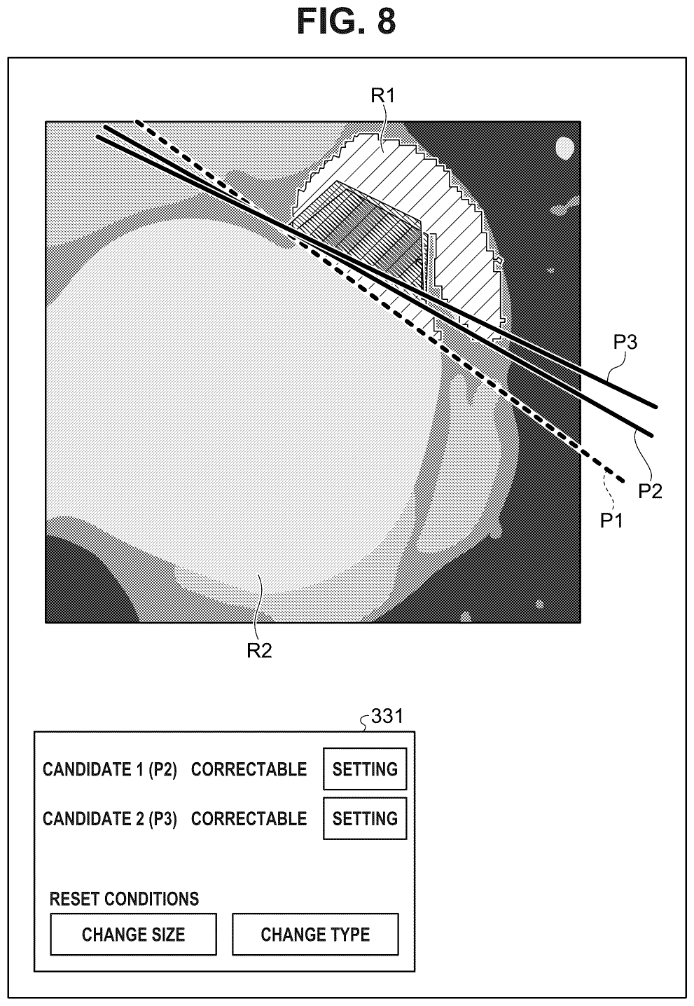

FIG. 8 is a diagram illustrating a display example according to the first exemplary embodiment. For example, as illustrated in FIG. 8, the control function 351 generates display information indicating the uncorrected plane P1, the corrected plane P2, and a corrected plane P3 on the CT image including the LA (region R2) and the LAA (region R1), and displays the generated display information on the display 33. Here, the planes P2 and P3 in FIG. 8 both satisfy the condition for the corrected position. In other words, if there is a plurality of planes satisfying the condition for the corrected position (the correction function 356 determines a plurality of planes to satisfy the condition), the control function 351 can generate display information indicating the respective positions and display the display information.

The control function 351 further displays a GUI for receiving user operations as illustrated in a display area 331 of the display example of FIG. 8. For example, as illustrated in the display area 331 of FIG. 8, the control function 351 displays a GUI that displays information indicating that corrections can be made like candidate 1 corresponding to the correction position of the plane P2 and candidate 2 corresponding to the correction position of the plane P3, along with setting buttons for accepting the respective corrections. The user presses the setting button corresponding to candidate 1 to accept the correction position of the plane P2. The user presses the setting button corresponding to candidate 2 to accept the correction position of the plane P3.

As illustrated in the display area 331 of FIG. 8, the control function 351 can further display a size change button and a type change button for resetting the condition if neither of the correction positions of candidates 1 and 2 is accepted. For example, the user can change the size and type of the treatment device by pressing the size change button and the type change button, respectively. In such a manner, display information including various GUIs can be displayed to make corrections more appropriate to the user.

### Third Modification

In the foregoing exemplary embodiment, the morphological information about a single treatment device is described as being acquired in step S104. However, the exemplary embodiment is not limited thereto. For example, morphological information about a plurality of treatment devices may be acquired. In such a case, the morphology acquisition function 355 acquires the morphological information about each of the treatment devices. The correction function 356 performs the operations in steps S105 and S106 on each of the treatment devices.

With the plurality of treatment devices processed as described above, the control function 351 can display the processing results related to the respective treatment devices. For example, the control function 351 displays the determinations as to whether to correct the plane P1 with the respective treatment devices placed on the plane P1 illustrated in FIG. 3 and, if the plane P1 is determined to be corrected, results of the correction processing device by device. Here, the control function 351 can highlight the type or size of a treatment device or devices having no correction position satisfying the condition among the treatment devices determined to be corrected, or display warning information.

### Fourth Modification

In the foregoing exemplary embodiment, the determination processing of step S105 with deformation information not being used as the morphological information about the treatment device has been described. A fourth modification deals with determination processing using deformation information. In such a case, for example, the morphology acquisition function 355 acquires morphological information including deformation information about the treatment device, as illustrated in FIG. 4B. The correction function 356 acquires the deformed morphology of the treatment device based on the deformation information, and corrects the reference plane or reference line based on the relationship between the deformed morphology of the treatment device and the morphology of the region of interest. The processing to be performed by the correction function 356 will now be described with reference to FIG. 5.

For example, as illustrated in FIG. 5, the correction function 356 calculates the expected placement position (region D1 in the diagram) of the treatment device based on the morphological information (diameter and height) about the treatment device and the plane P1. The correction function 356 then determines whether to correct the plane P1 based on the positional relationship between the calculated placement position of the treatment device and the LAA. If the deformation information about the treatment device is used, the correction function 356 here determines the positional relationship with the LAA while changing the size of the region D1 using the deformation information. For example, the correction function 356 reduces the diameter of the region D1 in FIG. 5 using the deformation information about the treatment device, and determines whether to correct the plane P1 based on the positional relationship with the contour of the LAA (region R1).

If the contour of the deformed treatment device (contour of the deformed region D1) falls within the contour of the LAA, the correction function 356 determines that correction of the plane P1 is unnecessary. If part of the deformed region D1 still lies outside the contour of the LAA, the correction function 356 determines that the plane P1 is to be corrected.

As described above, according to the first exemplary embodiment, the extraction function 353 extracts the region of interest from the medical image. The identification function 354 identifies the reference plane or the reference line based on the region of interest. The correction function 356 corrects the identified reference plane or reference line based on the morphology of the region of interest. The medical image processing apparatus 3 according to the first exemplary embodiment can thus correct the reference plane or the reference line based on the region of interest depending on the morphology of the region of interest, thus enabling identification of a reference plane or reference line suitable for clinical use.

According to the first exemplary embodiment, the morphology acquisition function 355 acquires the morphology of the treatment device to be placed in the region of interest. The correction function 356 corrects the reference plane or reference line based on the relationship between the morphology of the region of interest and the morphology of the treatment device. The medical image processing apparatus 3 according to the first exemplary embodiment can thus make a correction based on the morphology of the treatment device to be placed in the region of interest and the morphology of the region of interest, thus enabling identification of a reference plane or reference line suitable for clinical use.

According to the first exemplary embodiment, the correction function 356 sets candidate placement position(s) of the treatment device based on the reference plane or reference line. The correction function 356 corrects the reference plane or reference line based on the relationship between the state of the treatment device when placed at the candidate placement position and the morphology of the region of interest. The medical image processing apparatus 3 according to the first exemplary embodiment can thus make the correction based on the expected placement position of the treatment device, thus enabling identification of a reference plane or reference line more suitable for clinical use.

According to the first exemplary embodiment, the morphology acquisition function 355 further acquires the deformation information about the treatment device. The correction function 356 acquires the deformed morphology of the treatment device based on the deformation information, and corrects the reference plane or reference line based on the relationship between the deformed morphology of the treatment device and the morphology of the region of interest. The medical image processing apparatus 3 according to the first exemplary embodiment can thus make the correction based on the properties of the treatment device to be used, thus enabling identification of a reference plane or reference line more suitable for clinical use.

According to the first exemplary embodiment, the extraction function 353 extracts the region of interest from each of medical images in a plurality of time phases, collected over time. The correction function 356 corrects the reference plane or reference line based on the relationship between the morphology of the region of interest in each time phase and the morphology of the treatment device. The medical image processing apparatus 3 according to the first exemplary embodiment can thus identify a reference plane or reference line more suitable for clinical use with the region of interest changing its morphology over time.

### Second Exemplary Embodiment

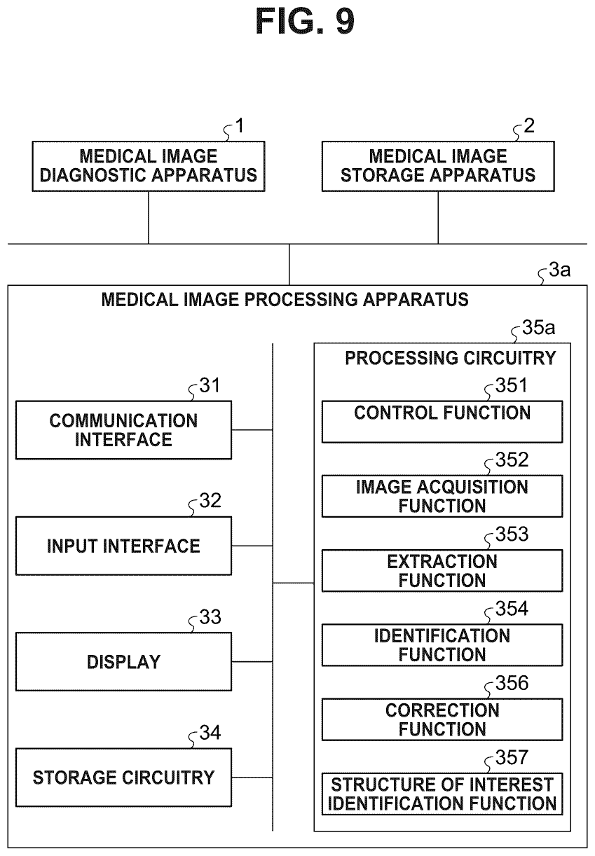

A second exemplary embodiment of the present disclosure will be described. In the first exemplary embodiment, the reference plane or reference line is described as being corrected based on the morphology of the region of interest and the morphology of the treatment device. The second exemplary embodiment deals with a case where the reference plane or reference line is corrected based on the morphology of the region of interest (the morphology of the region of interest and the morphology of a structure of interest included in the region of interest). FIG. 9 is a diagram illustrating a configuration example of a medical image processing apparatus 3a according to the second exemplary embodiment. The medical image processing apparatus 3a differs from the first exemplary embodiment in details of the processing to be performed by the correction function 356 and that processing circuitry 35a performs a structure of interest identification function 357. The following description focuses on these differences.

The structure of interest identification function 357 identifies a structure of interest included in the region of interest. Specifically, the structure of interest identification function 357 identifies a structure of interest that is a partial anatomical structure included in the region of interest (region of importance in the region of interest) to be reflected in setting the reference plane or reference line. The processing to be performed by the structure of interest identification function 357 will be described in detail below.

The correction function 356 according to the second exemplary embodiment corrects the reference plane or reference line based on the morphology of the region of interest and the morphology of the structure of interest. Specifically, the correction function 356 determines whether to correct the reference plane or reference line based on the morphology of the region of interest, the morphology of the structure of interest, and a positional relationship with the reference plane or reference line, and performs correction processing depending on the determination. The processing to be performed by the correction function 356 will be described in detail below.

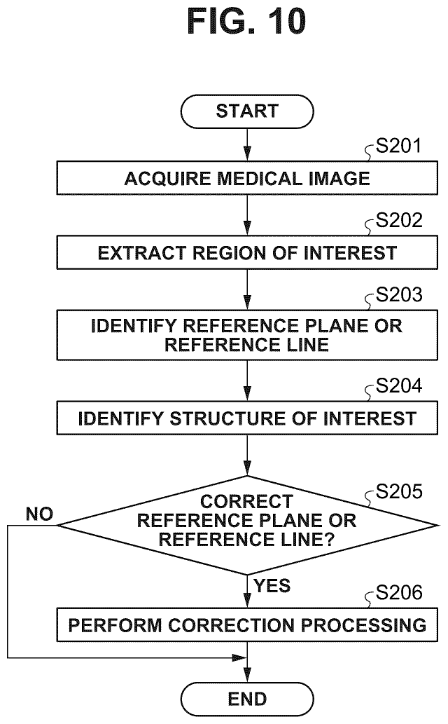

Next, a processing procedure of the medical image processing apparatus 3a will be described with reference to FIG. 10. Details of each process will then be described. FIG. 10 is a flowchart illustrating the processing procedure for the processing performed by the processing functions of the processing circuitry 35a of the medical image processing apparatus 3a according to the second exemplary embodiment. The operations in steps S201 to S203 in FIG. 10 are similar to those of steps S101 to S103 in FIG. 2. A detailed description thereof will thus be omitted.

For example, as illustrated in FIG. 10, in the present exemplary embodiment, an image acquisition function 352 acquires in step S201 a medical image of a subject. In step S202, an extraction function 353 extracts a region of interest included in the acquired medical image. In step S203, an identification function 354 identifies the reference plane or reference line based on the extracted region of interest.

In step S204, the structure of interest identification function 357 identifies a structure of interest included in the region of interest. This processing is implemented, for example, by the processing circuitry 35a calling a program corresponding to the structure of interest identification function 357 from storage circuitry 34 and executing the program.

In step S205, the correction function 356 determines whether to correct the identified reference plane or reference line. If the correction function 356 determines that the reference plane or reference line is determined to be corrected (YES in step S205), the processing proceeds to step S206. In step S206, the correction function 356 performs correction processing on the identified reference plane or reference line. If, in step S205, the correction function 356 determines that the reference plane or reference line is not to be corrected (NO in step S205), the processing is ended. Such processing is implemented, for example, by the processing circuitry 35a calling a program corresponding to the correction function 356 from the storage circuitry 34 and executing the program.

Details of the processes performed by the medical image processing apparatus 3a will now be described. The following description deals with a case where the region of interest is the LAA.

### (Processing for Identifying Structure of Interest)

As described in step S204 of FIG. 10, the structure of interest identification function 357 identifies the structure of interest included in the region of interest. Specifically, the structure of interest identification function 357 identifies positional information about the structure of interest of the LAA in a three-dimensional CT image. For example, the structure of interest identification function 357 extracts coordinate information about the coordinates of pixels representing the lobe of the LAA. Here, the structure of interest identification function 357 can identify the position of the structure of interest (lobe) using various techniques. For example, the structure of interest identification function 357 can identify a region specified on the CT image via the input interface 32 as the structure of interest (lobe). In other words, the structure of interest identification function 357 identifies a region manually specified by the user as the lobe.

As another example, the structure of interest identification function 357 can identify the structure of interest based on an anatomical structure drawn on the CT image using known region extraction techniques (such as Otsu's binarization, region growing, snake algorithm, graph cut, and mean shift based on CT values). As another example, the structure of interest identification function 357 can identify the lobe region (coordinate information) in the CT image using a trained model for the structure of interest (lobe), constructed using machine learning techniques (including deep learning) based on training data prepared in advance.

The foregoing method for identifying the structure of interest may be performed on only the vicinity of the region of interest (LAA) extracted in step S202. For example, only the interior of a rectangular solid circumscribing the region of interest may be assumed as the target of the identification processing (range to be searched for the structure of interest). The interior of the region of interest may be excluded from the identification processing. Such ranges may be combined so that the structure of interest is identified with only a range in the vicinity of and outside the region of interest to be subjected to the identification processing.

### (Determination Processing Related to Correction)

As described in step S205 of FIG. 10, the correction function 356 determines whether to correct the reference plane or reference line based on the morphology of the region of interest, the morphology of the structure of interest, and the positional relationship with the reference plane or reference line. For example, the correction function 356 determines whether to correct the reference plane or reference line based on the position of the reference plane or reference line with respect to the region of interest and the structure of interest.

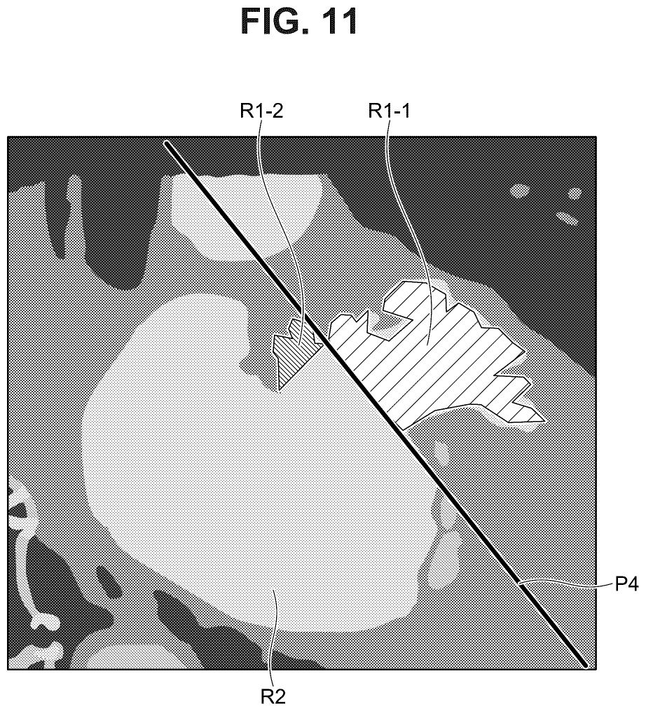

FIG. 11 is a diagram for describing an example of the determination processing to be performed by the correction function 356 according to the second exemplary embodiment. FIG. 11 illustrates a state where a region R1-1 is extracted as the LAA region, a plane P4 is identified as the ostium plane, and a region R1-2 is identified as the lobe. A region R2 represents the LA region. For example, the correction function 356 acquires information about the plane P4 identified by the identification function 354, information about the region R1-1 extracted by the extraction function 353, and information about the region R1-2 identified by the structure of interest identification function 357. The correction function 356 then determines whether to correct the plane P4 based on the position of the plane P4 with respect to the region R1-1 and the region R1-2.

For example, in FIG. 11, the lobe (region R1-2) lies on the LA-side (region R2-side) of the plane P4. Thus, the blood will presumably flow into the lobe after the treatment device is placed at this position, the correction function 356 determines that the treatment device is not to be placed along the plane P4, and determines that the plane P4 is to be corrected. In other words, the correction function 356 determines whether to correct the plane P4 with the presence or absence of the lobe on the LA-side of the plane P4 as the determination criterion.

If no structure of interest is identified by the structure of interest identification function 357, the correction function 356 may determine that correction of the reference plane or the reference line is unnecessary.

### (Correction Processing)

As illustrated in step S206 of FIG. 10, if the correction function 356 determines that the reference plane or reference line is to be corrected in step S205, the correction function 356 performs the correction processing on the reference plane or reference line. Specifically, the correction function 356 corrects the reference plane or reference line to a position where the reference plane or reference line is determined not to be corrected by the determination criterion that is used to determine that the correction is to be made in step S205, based on the positional information about the region of interest and the positional information about the structure of interest.

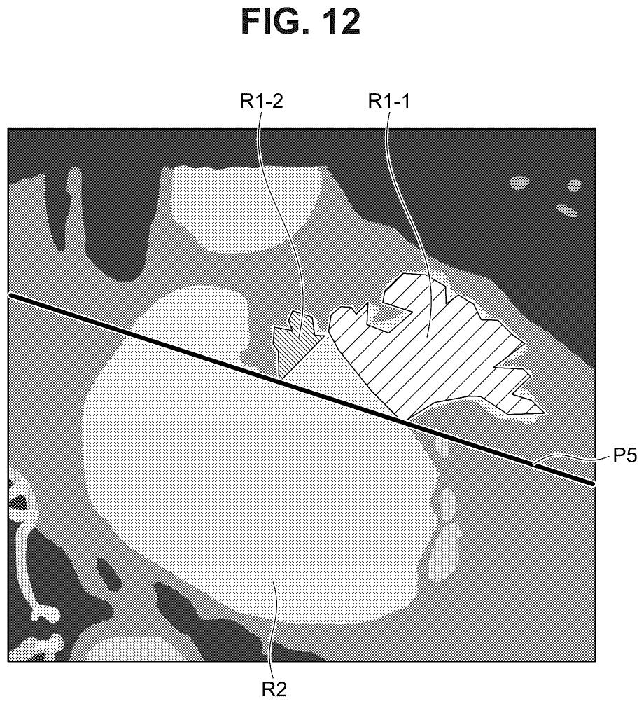

FIG. 12 is a diagram for describing an example of the correction processing to be performed by the correction function 356 according to the second exemplary embodiment. FIG. 12 illustrates the processing after the determination processing of FIG. 11. For example, as illustrated in FIG. 12, the correction function 356 calculates the correction position of the reference plane (plane P5) from the contour of the LAA (region R1-1) and the contour of the lobe (region R1-2) so that the lobe (region R1-2) does not fall on the LA-side of the reference plane, and determines the calculated plane P5 as the corrected plane. As in the first exemplary embodiment, the correction function 356 can determine the correction position using various methods.

In the foregoing example, a single structure of interest is described as being identified. However, the exemplary embodiment is not limited thereto, and two or more structures of interest may be identified. Structures of interest are not limited to ones that every subject has, such as a lobe mentioned above, and may be ones that a specific subject has.

As described above, according to the second exemplary embodiment, the structure of interest identification function 357 identifies the structure of interest included in the region of interest. The correction function 356 corrects the reference plane or reference line based on the morphology of the region of interest and the morphology of the structure of interest. The medical image processing apparatus 3a according to the second exemplary embodiment can thus correct the reference plane or reference line based on the region of interest depending on the morphology of the structure of interest included in the region of interest, and enables identification of a reference plane or reference line suitable for clinical use.

### Other Exemplary Embodiments

The foregoing exemplary embodiments have dealt with the cases where a reference plane (e.g., plane P1) is subjected to correction as a reference position in measuring the region of interest or determining the treatment device during treatment planning. However, the exemplary embodiments are not limited thereto, and a reference line may be subjected to connection as a reference position in measuring the region of interest or determining the treatment device during treatment planning. In such a case, for example, two lines each passing two of three points included in the border between the LA and the left ventricle may be generated and the generated two lines may be subjected to correction.

In the foregoing exemplary embodiments, the LAA is described as the region of interest. However, the exemplary embodiments are not limited thereto, and the region of interest may be the aortic valve or the mitral valve.

If the region of interest is the aortic valve, the present method is applicable to processing for correcting the reference plane in replacing the aortic valve with an artificial valve. In such a case, for example, the extraction function 353 extracts the anatomical structure of the aortic valve and its vicinity in the CT image as the region of interest. The identification function 354 identifies a reference plane serving as a reference in implantation of an artificial valve included in the CT image based on the morphology of the extracted aortic valve. The morphology acquisition function 355 acquires the morphological information about the artificial valve. The correction function 356 determines whether to correct the reference plane based on the morphology of the region of interest and the morphology of the artificial valve, and corrects the reference plane depending on a result of the determination.

For example, the correction function 356 determines whether to correct the reference plane based on the positional relationship between the artificial valve after deployment and the entrance of the coronary artery included in the region of interest when the artificial valve is deployed on the reference plane identified by the identification function 354. For example, if the distance between the artificial valve and the entrance of the coronary artery is less than a threshold, the correction function 356 determines that the reference plane is to be corrected, and corrects the reference plane so that the distance between the artificial valve and the entrance of the coronary artery is greater than or equal to the threshold.

If the region of interest is the mitral valve, the present method is applicable to processing for correcting the reference plane in placement of MITRACLIP (registered trademark) on the mitral valve. In such a case, for example, the extraction function 353 extracts the mitral valve included in the CT image as the region of interest. The identification function 354 identifies a reference plane serving as a reference in placement of MITRACLIP based on the morphology of the extracted mitral valve. The morphology acquisition function 355 acquires the morphological information regarding MITRACLIP. The correction function 356 determines whether to correct the reference plane based on the morphology of the mitral valve and the morphology of MITRACLIP, and corrects the reference plane depending on the determination.

For example, the correction function 356 determines whether to correct the reference plane identified by the identification function 354 based on the positional relationship between MITRACLIP and the mitral valve after deployment when MITRACLIP is deployed on the reference plane. For example, if the size of MITRACLIP is greater than the leaflet length of the mitral valve along the reference plane, the correction function 356 determines that the reference plane is to be corrected, and corrects the reference plane so that the size of MITRACLIP is less than the leaflet length of the mitral valve along the reference plane.

The processing circuitry described in each of the foregoing exemplary embodiments may be configured by combining a plurality of independent processors, and the processing functions may be implemented by the processors executing the programs. The processing functions of the processing circuitry may be implemented on a single processing circuit or a plurality of processing circuits in an appropriately distributed or integrated manner. The processing functions of the processing circuitry may be implemented by a combination of hardware, such as a circuit, and software. While the programs corresponding to the processing functions have been described as being stored in single storage circuitry 34, the exemplary embodiments are not limited thereto. For example, the programs corresponding to the processing functions may be distributedly stored in a plurality of storage circuits, and the processing circuitry may be configured to read the programs from the storage circuits and execute the programs.

In the foregoing exemplary embodiments, the components set forth in this specification are described as being implemented by respective functions of a processing circuitry. However, the exemplary embodiments are not limited thereto. For example, instead of the function-based implementation described in the exemplary embodiments, the components set forth in the specification may be implemented by only hardware, only software, or a combination of hardware and software.

The term “processor” used in the description of the foregoing exemplary embodiments refers to a circuit such as a central processing unit (CPU), a graphics processing unit (GPU), an application specific integrated circuit (ASIC), and a programmable logic device (e.g., a simple programmable logic device [SPLD], a complex programmable logic device [CPLD], or a field programmable gate array [FPGA]). Instead of storing the programs in the storage circuit, the programs may be directly built in the processor circuit. In such a case, the processor implements the functions by reading the built-in programs in its own circuit and executing the programs. The processors according to the exemplary embodiments are not limited to a single-circuit configuration. A plurality of independent circuits may be combined into a processor that implements the functions.

A medical image processing program to be executed by the processor is provided as a built-in program in a read-only memory (ROM) or other storage circuits. This medical image processing program may be provided recorded on a computer-readable non-transitory storage medium such as a compact disk read-only memory (CD-ROM), a flexible disk (FD), a compact disk recordable (CD-R), and a digital versatile disk (DVD), in a file format installable or executable on the apparatuses. The medical image processing program may be stored on a computer connected to a network such as the Internet, and provided or distributed through downloading over the network. For example, the medical image processing program includes modules including the foregoing processing functions. In terms of actual hardware, a CPU reads the medical image processing program from a storage medium such as a ROM and executes the program, whereby the modules are loaded into and generated on a main storage device.

In the foregoing exemplary embodiments and modifications, the components of the apparatuses illustrated in the diagrams are functional concepts and do not necessarily need to be physically configured as illustrated in the diagrams. In other words, the specific forms of distribution or integration of the apparatuses are not limited to the illustrated ones, and all or part of the apparatuses can be functionally or physically distributed or integrated into any units depending on various loads and usages. All or part of the processing functions for the apparatuses to perform can be implemented by a CPU and programs to be analyzed and executed by the CPU, or as wired logic hardware.

All or part of the processes described to be automatically performed in the foregoing exemplary embodiments and modifications can be manually performed. All or part of the processes described to be manually performed can be automatically performed using known methods. Furthermore, the processing procedures, control procedures, specific names, and information including various types of data and parameters described above or illustrated in the drawings can be freely modified unless otherwise specified.

According to at least one of the exemplary embodiments described above, a reference plane or reference line suitable for clinical use can be identified.

While several exemplary embodiments have been described, these exemplary embodiments are presented by way of example only, and not intended to limit the scope of the invention. The exemplary embodiments can be practiced in various other forms, and various omissions, replacements, and modifications can be made without departing from the gist of the invention. Such exemplary embodiments and their variations are encompassed by the scope and gist of the invention, as well as by the invention set forth in the claims and the range of equivalency thereof.

What is claimed is:

1. A medical image processing apparatus comprising processing circuitry configured to:
extract a region of interest from a medical image;
identify a reference plane or a reference line based on the region of interest; and
correct the identified reference plane or the identified reference line based on a morphology of the region of interest.

2. The medical image processing apparatus according to claim 1, wherein the processing circuitry is further configured to acquire a morphology of a treatment device to be placed in the region of interest,
wherein the processing circuitry is configured to correct the reference plane or the reference line based on a relationship between the morphology of the region of interest and the morphology of the treatment device.

3. The medical image processing apparatus according to claim 2, wherein the processing circuitry is further configured to set a candidate placement position for the treatment device based on the reference plane or the reference line,
wherein the processing circuitry is configured to correct the reference plane or the reference line based on a relationship between a state of the treatment device in a case where the treatment device is placed at the candidate placement position and the morphology of the region of interest.

4. The medical image processing apparatus according to claim 2,
wherein the processing circuitry is configured to
further acquire deformation information about the treatment device, and
acquire a deformed morphology of the treatment device based on the deformation information, and correct the reference plane or the reference line based on a relationship between the deformed morphology of the treatment device and the morphology of the region of interest.

5. The medical image processing apparatus according to claim 2,
wherein the processing circuitry is configured to
extract the region of interest from each of medical images in a plurality of time phases, collected over time, and
correct the reference plane or the reference line based on a relationship between the morphology of the region of interest in each of the plurality of time phases and the morphology of the treatment device.

6. The medical image processing apparatus according to claim 1, wherein the processing circuitry is further configured to identify a structure of interest included in the region of interest,
wherein the processing circuitry is configured to correct the reference plane or the reference line based on the morphology of the region of interest and a morphology of the structure of interest.

7. A method comprising:
extracting a region of interest from a medical image;
identifying a reference plane or a reference line based on the region of interest; and
correcting the identified reference plane or the identified reference line based on a morphology of the region of interest.

8. A non-transitory computer-readable medium storing a program for causing a computer to:
extract a region of interest from a medical image;
identify a reference plane or a reference line based on the region of interest; and
correct the identified reference plane or the identified reference line based on a morphology of the region of interest.
